(19) United States
(12) Patent Application Publication
(10) Pub. No.: US 2014/0361033 A1
(43) Pub. Date: Dec. 11, 2014

(54) STACK OF A WEB MATERIAL AND METHOD FOR PRODUCING THE SAME

(71) Applicant: Anders Andersson, Stenungsund (SE)

(72) Inventor: Anders Andersson, Stenungsund (SE)

(73) Assignee: SCA Hygiene Products AB, Göteborg (SE)

(21) Appl. No.: 14/375,561

(22) PCT Filed: Jan. 30, 2012
(86) PCT No.: PCT/SE2012/050088

§ 371 Date: Aug. 21, 2014

(51) Int. Cl. A47K 10/42; B31F 7/00; B65H 45/20; A47K 10/16; B31D 1/04

(52) U.S. Cl. CPC A47K 10/42; A47K 10/16; B31D 1/04; B65H 45/20; B31F 7/00; A47K 2010/428
USPC 221/33; 428/43; 493/357; 493/411

(57) ABSTRACT

A stack of a web material, such as a tissue web material, said stack having fold lines (fn) extending laterally across the web, the distance between two consecutive fold lines being equal to the stack width (sw), and perforation lines (pn) extending laterally across the web, to form sheets of web material having a length corresponding to the distance between consecutive perforation lines (pn), the majority of said sheets having sheet lengths being greater than the stack width (sw) and other than evenly divisible with the stack width (sw), wherein the perforation lines (pn) are positioned along the web material such that all perforation lines are located at least a distance M from any fold lines in the stack, such that all perforation lines are separate from any fold lines in the stack. Also, a method for producing said stack.

### TECHNICAL FIELD

The present disclosure relates to a stack of a web material, preferably for forming hygiene products, such as a tissue web material, said stack having fold lines extending laterally across the web, the distance between two consecutive fold lines being equal to the stack width, and perforation lines extending laterally across the web, to form sheets of web material having a length corresponding to the distance between consecutive perforation lines, the majority of said sheets having sheet lengths being other than evenly divisible with the stack width.

### TECHNICAL BACKGROUND

Towels, napkins and similar products for personal use and household use are used for many different purposes and industries for cleaning and machine wiping, in washing stations, in toilets, in offices and public premises. Different products can consist of a number of different qualities and constitute different hygiene- or wiping material, such as paper and tissue. Synthetic materials, natural materials and non-woven mixtures thereof may also be used. The products may have different uses and can among other things be used for hygiene, wiping, absorption, cleaning and polishing. Among some of the products that can be mentioned are paper towels, towels, different types of cloths, facial tissue, cosmetic tissue, napkins, kitchen towels, toilet paper and washing cloths.

The products may be stored as separate products, such as a pile of separate paper napkins arranged on top of each other or side-by-side. However, the disclosure relates to the case where the products are stored as a web of a hygiene- or wiping material, where the web of material will, in its length direction, be divided into sheets, i.e. separate products before use. The webs of materials may be provided as a roll, or as is the subject of the disclosure, in a folded pile.

Such a roll or pile of web material is normally stored in a dispenser especially adapted for this purpose, for example a dispenser for consumer use. Such dispensers are often found in restrooms or restaurants, where the products are available for employees, the public, customers and clients. They may for example be placed on the wall, posts or the like. They are often free of charge for the user of the products and these types of product are often frequently and not especially sparingly used. Thus it is important to be able to optimize the storing capacity of dispensers in order to avoid the need of a frequent refilling of the dispensers.

A type of dispenser frequently encountered in the washrooms of airports, restaurants or other settings with a high frequency of customers is a dispenser from which the products are withdrawn from stacks of folded material webs, where the webs are divided into products by transversely extending perforation lines. The material web is typically folded in an accordion-like manner to form the stack, and the leading end of the material web is drawn from the stack to a dispensing opening of the dispenser so as to be presented to a user. The perforations may advantageously be broken inside the dispenser, such that the user is presented with a separate product. Alternatively, the perforations may be broken manually by the user.

WO03/034885 describes a web material provided in a folded stack. The web is divided in its length direction in separate or partly interconnected sheets extending between transverse separations or perforations. The web, as well as the sheets, is folded in accordion-like manner about transverse folding lines, so that panels are formed and piled on top of each other, wherein the stack has a panel width constituting the distance between adjacent folding lines and a panel length which is the same as the web width. The majority of the sheets comprised in a pile have a length, which is not divisible with the panel width. Consecutive separations or perforations are placed so that one separation or perforation in the stack will not be straight above and thus not vertically aligned with the previous or next separation or perforation of the same web.

The stack as described in WO03/034885 has the advantage that, with the sheet length (the distance between two consecutive perforations) not being integrally divisible with the panel width, the sheet length may be freely selected and is no longer determined by factors such as the depth of the dispenser into which the stack is to be inserted. In a stack as described in WO03/034885, the location of the perforation lines in relation to the fold lines will vary along the stack. Hence, as seen from the side of the stack, the locations of the perforation lines will “wander” over the width of the stack.

This is believed to provide another advantage, namely to provide a stable stack, since perforation lines e.g. located on top of each other might result in stack having an uneven height and hence becoming unbalanced.

In view of the above, it is desired to provide a stack as described in WO03/034885.

However, when using stacks as described in WO03/034885, and also with some other known stacks, it has been found that, when the material web is drawn from the pile via a dispensing arrangement to a dispensing outlet, there are sometimes imperfections in the feeding of the web. Such feeding generally involves the passing of the web through a number of feeding arrangements, such as nips formed between opposing rollers. If the material web is not smoothly fed through the dispensing arrangement, the result might be an uneven speed of the dispensing. Also, the material web may risk getting stuck or rupturing when inside the arrangement.

Uncontrolled variations in the dispensing speed and/or other irregularities occurring during the feeding of the web material are particularly problematic for the cases where the stack includes two interfolded material webs. In such arrangements, the webs may be arranged such that the perforation lines of one web will be positioned in-between the perforation lines of the other web, such that the product sheets of the two webs are arranged in a staggered relationship. Both webs are fed in parallel through the dispenser, and the staggered relationship is useful in that the withdrawal of a product from the first web will drag along the leading end of the second web for presentation to a user. Hence, a manually driven feeding of the products may be accomplished.

For the feeding of the two webs from the stack to work properly, it is desired that the two webs propagate simultaneously, with the same speed and without irregularities through the dispenser. Otherwise, the relative arrangement between the two webs risks becoming disturbed, such that the intended automatic manual feeding arrangement does not function.

It is an object of certain embodiments of the disclosure to diminish or remove problems relating to irregularities when feeding a material web through a dispenser from a stack of accordion-folded web material.

### SUMMARY

The above-mentioned object is achieved by a stack and a method in accordance with the independent claims as enclosed.

Hence, there is proposed herein a stack of a web material, such as a tissue web material, said stack having fold lines extending laterally across the web, the distance between two consecutive fold lines being equal to the stack width (sw), and perforation lines extending laterally across the web, to form sheets of web material having a length corresponding to the distance between consecutive perforation lines, the majority of said sheets having sheet lengths being other than evenly divisible with the stack width (sw). Moreover, the perforation lines are positioned along the web material such that all perforation lines are located at least a distance M from any fold lines in the stack, such that all perforation lines are separate from any fold lines in the stack.

Accordingly, the stack is similar to the stack described in WO03/034855, in that the lengthwise relationship between the fold lines (forming the sides of the stack) and the perforation lines will vary along the length of the web (or the height of the stack).

In a stack as described in WO03/034885, as well as in many other prior art stacks, the perforation lines will sometimes (or always) coincide with fold lines. This has not hitherto been considered a problem. Indeed, in some prior proposed stacks, it is desired to position the perforation lines precisely at the fold lines.

However, it has been realised that when a perforation line coincides with a fold line, this results in the fold line becoming “sharper” than other fold lines, not coinciding with a perforation line. In particular it has been found that, when the stack is unfolded for dispensing of the web material, a fold line which coincided with a perforation line tends to remain in the material web to a further extent than other fold lines. Hence, the fold line coinciding with a perforation line might result in an extra crease in the unfolded web material. This crease may in turn pose problems when the unfolded web material is fed through the dispenser. Hence, the crease created by a perforation line coinciding with a fold line gives rise to an irregularity in the material web, which is undesired.

With “perforation lines” is meant herein perforation lines which are intended to separate the web material into separate product sheets. The sheets themselves may be provided with other perforations or apertures, but these are not encompassed by the term “perforation lines” as used herein.

In accordance with the disclosure, a stack is provided having “wandering” perforation lines (the distance between the sides of the stack (the fold lines) and the perforation lines varies along the stack), but in which no perforation lines coincide with, or lay within a distance M from, any fold lines of the stack.

The distance M is defined as the distance along the web material between the centre of a fold line and the centre of a perforation line. However, it is understood that a perforation line having a width in the direction of the web, such that the perforations have areas extending over the location of the fold line is not considered as being “separate from the fold line” even if the centre of the perforation line is more than a distance M from the centre of the fold line.

Moreover, for the perforation lines to be separate from the fold lines, it is understood that M is greater than 0.

Naturally, the distance M in both directions (upstream and downstream) of the web will be free from perforation lines in the stack.

The distance M may advantageously be less than or equal to 2% of the stack width (sw), preferably less than or equal to 5% of the stack width, most preferred less than or equal to 10% of the stack width.

In an alternative expression, the distance M may advantageously be less than or equal to 2 mm, preferably 5 mm, most preferred 10 mm.

It is envisaged, that a stack having no perforation lines within a distance M from any fold lines, may be accomplished by a suitable distribution of the perforation lines. Such a distribution may result in the distances between two consecutive perforation lines varying along the web material. Hence, the stack will advantageously comprise at least two sheets having different sheet lengths, said two sheets not including the end sheets of the stack.

The length of the end sheets of the stack may namely be varied for other reasons than for the purpose of selecting suitable positions of the perforation lines. Instead, as is known in prior art, the lengths of the end sheets may be adapted to factors such as cutting arrangements, or to specific demands on the end of the stack for accomplishing e.g. connection to other stacks or to outer wrappers and the like.

Advantageously, the majority of the sheets in the stack may have a nominal sheet length (sl), said nominal sheet length (sl)=((an integer+a)×sw)), where 0<a<1. In this case, most of the sheets of the stack will have the nominal sheet length, which is set such that the locations of the perforations will wander along the width of the stack. However, in order to ensure that no perforation lines are present within the distance M from any fold lines in the stack, some sheets of the stack may have a sheet length other than the sheet nominal sheet length.

Hence, advantageously, the stack comprises at least one sheet having a sheet length different than the nominal sheet length (sl), which at least one sheet is not an end sheet of the stack. Again, the end sheets are not relevant as the lengths thereof may be adapted for other purposes.

Advantageously, for each sheet in the stack having a sheet length being different than the nominal sheet length (sl), and not being an end sheet of the stack, the difference between the length of that sheet and the nominal sheet length (sl) may be below an allowed length variation value (Ivv). In this manner, the length of the sheets may vary between the nominal sheet length sl plus/minus the allowed length variation value (Ivv). Accordingly, it is ensured that all sheets of the stack (but the end sheets) are within a range which is deemed suitable for the purposes for which the sheets are intended. Moreover, the allowed length variation value (Ivv) and the sheet length (sl) may be selected to suit a particular dispenser or feeding arrangement.

Advantageously, an allowed length variation value (Ivv) may be less than 25% of the nominal sheet length (sl), preferably less than 15% of the nominal sheet length (sl), most preferred less than 10%.

The stack may advantageously comprise a number of sheets n being greater than equal to sw/a, when the nominal sheet length is (sl)=((an integer+a)×sw)), where 0<a<1.

In a stack where all sheets have the nominal sheet length, there will be at least one fold line coinciding with a perforation line if the stack comprises a number of sheets n being at least sw/a.

Preferably, the stack comprises at least 20 sheets, more preferred at least 50 sheets, most preferred at least 100 sheets.

Suitable stack widths may be between 4 and 20 cm, preferably between 7 and 15 cm.

Suitable sheet lengths, preferably nominal sheet lengths, may be between 8 and 80 cm, preferably between 8 and 40 cm, most preferred between 20 and 40 cm.

Advantageously, the ratio between the sheet length and the stack width may be between 2 and 8, preferably between 2 and 5, most preferred between 3 and 4.

It will be understood, that with the stack proposed herein, a wide range of stack widths may be accomplished, as the stack may be accomplished without restrictions as to certain combinations of e.g. stack widths and sheet lengths.

When the nominal sheet length is (sl)=((an integer+a)×sw), the integer may be preferably be greater than or equal to 1, preferably in the range 1 to 8, more preferred in the range 2 to 5, most preferred the integer may be 3 or 4.

Preferably, a may be greater than 0.05, preferably in the range 0.1 to 0.5, most preferred between 0.2 and 0.4. The perforations will, when the sheets have the nominal sheet length, wander with the distance a×sw in the stack.

Advantageously, (an integer+a) is in the range 2-4, preferably 3-4.

Advantageously, the perforation lines are formed by alternating bonds and slots, and a remaining bonded length being the total bond length/(total bond length+total slot length) is between 4% and 50%, preferably between 4% and 25%, most preferred between 4% and 15%. The total bond length/(the total bond length+total slot length) may be used as an indication of the strength of the perforation line. It is desired to form perforation lines which are strong enough to enable feeding of the web material from the stack in a suitable dispenser, but which are also weak enough to enable separation of the sheets along the perforation lines. In this context, it is known that also other parameters may influence the strength of the perforation line, such as the paper quality, and the size, shape and distribution of the slots and tabs. However, it is believed that the above-mentioned measure is nevertheless useful for guiding the person skilled in the art when selecting suitable perforation lines.

In one embodiment, the stack may comprise two separate web materials being interfolded. Such stacks are desired for example in certain types of dispensers.

Preferably, the two web materials are interfolded in relation to each other such that the location of each perforation line of the first web material is positioned between two consecutive perforation lines of the second web material. This configuration is particularly suitable for arrangements with manual feeding of the web material. When a person pulls the end sheet of one of the webs from a dispenser, the end sheet of the second of the webs will be dragged along, so as to be presented to a user.

Advantageously, the first perforation line of the web is positioned at a distance equal to the sheet length from a leading edge of the web. In this case, also the end sheet may have e.g. the nominal sheet length.

Preferably, at least one end of the stack is provided with a connection member for connection to the web material of another stack, when the stack is introduced in a dispenser for dispensing the web product. Such a connection member could be formed by any suitable means, such as an adhesive, a double-sided tape or a mechanical connection such as a Velcro connection. The connection member could initially be covered by a release paper or the like, to be removed before use thereof.

Advantageously, the stack may be provided with a wrapper at least partly surrounding the stack before use thereof.

In one embodiment there is provided a stack wherein, when looking from a first end of the web material towards a second end of the web material,
the web material has a first fold line, and a number of following fold lines, the position of each following fold line being at the distance sw from a previous fold line,
the web material has a first perforation line, and a number of following perforation lines, and
for each following perforation line, if the previous perforation line plus sl is not within a distance M from any fold line of the stack, the position of the following perforation line is at a distance sl from a previous perforation line,
but if the previous perforation line plus sl is within a distance M from any fold line of the stack, the position of the following perforation line is at a distance sl plus an offset value from a previous perforation line.

Hence, in a stack as the one described above, it is seen that perforation lines that would become positioned within the distance M from a fold line, if all sheets had the nominal sheet length sl, are “moved” to another location by varying the sheet length with an offset value.

The offset value may vary from perforation line to perforation line. At least, the offset value must naturally be great enough to ensure that the new final location of the perforation line is positioned at least the distance M from the fold line.

However, for practical reasons, the offset value might suitably be a constant. The offset value may be a positive as well as a negative value.

The offset value should advantageously be within said allowable length variation value (Ivv), where such a value is defined.

In a variant of the above-mentioned embodiment, the stack may be formed such that, when considering three consecutive perforation lines, where the position of the second perforation line is at a distance of the sheet length (sl) plus an offset value from the first perforation line, the third perforation line is located at a distance being a sheet length from the second perforation line.

In this case, it may be seen how a first sheet has the nominal sheet length, said first sheet being followed by a second sheet having a different sheet length, being the nominal sheet length plus an offset value, so as to ensure that the perforation line delimiting the second sheet will not come within the distance M of a fold line. After the second sheet, a third sheet will follow, which will have the nominal sheet length. Hence, only one sheet will have a different sheet length than the nominal sheet length.

In another variant of the above-mentioned embodiment, the stack may be formed such that, when considering three consecutive perforation lines, where the position of the second perforation line is at a distance of the sheet length (sl) plus an offset value from the first perforation line, the third perforation line is located at a distance being two sheet lengths from the second perforation line.

In this case, it may be seen how a first sheet has the nominal sheet length, said first sheet being followed by a second sheet having a different sheet length, being the nominal sheet length plus an offset value, so as to ensure that the perforation line delimiting the second sheet will not come within the distance M of a fold line. After the second sheet, a third sheet will follow, which will also have a different sheet length, namely the nominal sheet length minus an offset value. Thereafter, a next sheet might have the nominal sheet length again. Hence, two consecutive sheets will have a different sheet length than the nominal sheet length.

Variants such as those above may be also be combined and used in various manners in a single stack.

In a second aspect of the disclosure, there is provided a method for producing a stack of a folded and perforated web material in accordance with the above, said method comprising:
providing a web section of a web material,
selecting a stack width (sw), being equal to the distance between two consecutive fold lines of said web material,
determining the final positions of the fold lines along the web material;
determining the final positions of the perforation lines along the web material, by distributing the perforation lines such that
   the majority of the sheets formed between consecutive perforation lines have a sheet length being other than evenly divisible with the stack width (sw); and
   all final positions of the perforation lines are located at least a distance M along the web material from any fold line,
directing the web material to a perforating station,
perforating the web material at the determined final positions of the perforation lines;
directing the web material to a folding station, and
folding the web material at the determined final positions of the fold lines to form said stack.

A suitable distribution of the perforation lines may be performed in various manners. For example, different distributions may be generated and evaluated by a computer program. Different distributions may be optimized for various parameters. A selected distribution of the perforation lines may be given as input to a controller for controlling the perforating of the web material.

Advantageously, the web section may be formed from a continuous web of material the method further comprising the step of directing the continuous web to a cutting station and cutting the continuous web into web sections.

Preferably, said step of cutting the continuous web into web sections is performed after the step of perforating the web material and before step of folding the web material.

In this way, the distribution and application of the perforation lines may be performed independent of the later cutting of the web. The lengths of the web sections, and hence the size of the stacks, may be varied without affecting the locations of the perforation lines and the fold lines.

Advantageously, the method may start by selecting the position of a first fold line on the web material, and determining the final positions of the fold lines along the web material by, for each next fold line, adding the stack with (sw) to the position of a previous fold line.

Preferably, the method comprises selecting a nominal sheet length (sl), being a nominal distance between two consecutive perforation lines of the web material, where sl=(an integer+a)×sw, where 0<a<1, and
distributing the perforation lines such that a majority of the sheets formed by the method will have the nominal sheet length (sl).

Advantageously, the method may comprise selecting an allowed length variation value (Ivv), and distributing the perforation lines such that all sheets between the end sheets of the stack will have sheet lengths within the range of the nominal sheet length+−the allowed length variation value.

Advantageously, the method may comprise determining the final positions of the perforation lines along the web by selecting the position of a first perforation line on the web material, and determining the nominal position of each next perforation line along the web material by adding the nominal sheet length sl to the position of a previous perforation line, comparing the nominal position of said next perforation line with the final positions of the fold lines, and,
if the nominal position of the next perforation line is located at a distance less than M from any fold line, create a final position for the next perforation line being at least a the distance M from any fold line by adding an offset value to the nominal position, or
if the nominal position of the next perforation line does not coincide with the position of any fold line, the nominal position for the next perforation line becomes the final position.

In one variant, a next perforation line following a previous perforation line whose final position was achieved by adding an offset value to the nominal position, the “previous fold line” is the final position of the previous perforation line.

In another variant, for a next perforation line following a previous perforation line whose final position was achieved by adding an offset value to the nominal position, the “previous fold line” is the nominal position of the previous perforation line.

In one embodiment, the method comprises forming a stack of two perforated web materials, said web materials being interfolded to form said stack.

Advantageously, said perforating and interfolding of the two web materials is controlled such that each perforation line of the first web material is positioned between two consecutive perforation lines of the second web material.

Other features and advantages as explained in relation to the stack proposed herein may equally be applied to the method proposed herein.

In a third aspect, the disclosure relates to a dispenser for dispensing sheets of web material to a user, said dispenser containing a stack in accordance with the disclosure.

Preferred web materials for use with the disclosure are such that are known in the field of folded hygiene products. Moreover, the web material should preferably be of a type suitable for dispensing via a dispenser unit to a user.

### BRIEF DESCRIPTION OF THE DRAWINGS

In the following, the disclosure will be described by means of exemplary embodiments thereof and with referenced to the enclosed drawings. In the drawings,

FIG. 1 illustrates schematically a portion of a stack in accordance with an embodiment of the disclosure, as seen from a side of the stack;

FIG. 2 illustrates schematically a portion of the web material in the portion of the stack of FIG. 1;

FIG. 3 schematically shows an embodiment of a stack in accordance with another embodiment of the disclosure, comprising two interfolded web materials;

FIG. 4 schematically illustrates a perforation line;

FIG. 5 schematically illustrates an embodiment of an apparatus for carrying out an embodiment of a method in accordance with the disclosure;

FIG. 6 schematically illustrates another embodiment of an apparatus for a carrying out an embodiment of a method in accordance with the disclosure; and

FIG. 7 schematically illustrates yet another embodiment of an apparatus for carrying out an embodiment of a method in accordance with the disclosure.

Similar reference numbers are used for similar features in the different drawings.

### DETAILED DESCRIPTION OF EMBODIMENTS

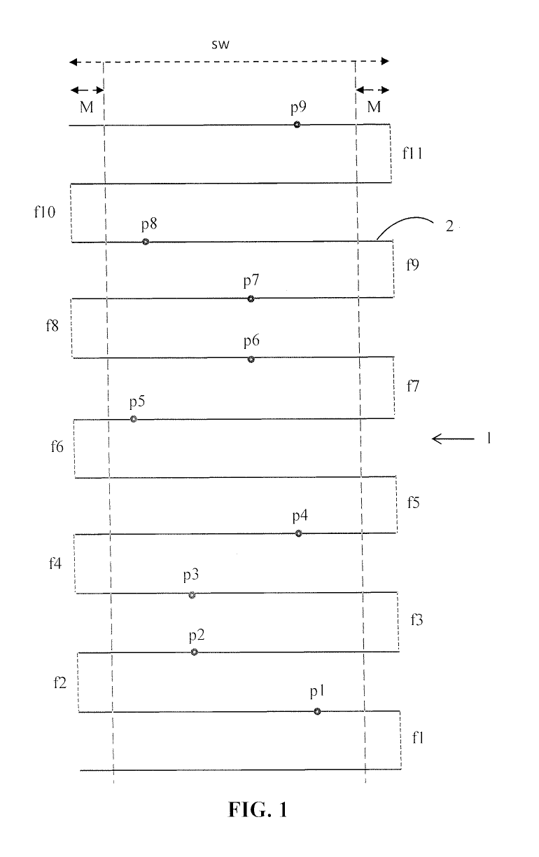

FIG. 1 schematically illustrates a portion of a stack 1 of a folded web material 2. The web material 2 is folded in an accordion-like manner along fold lines fn. The illustrated portion of the stack 1 includes eleven fold lines f1 to f11. The distance between two consecutive fold lines fn and fn+1 corresponds to the width of the stack sw. Hence, the web 2 is folded into panels having the stack width, and the stack 1 is constituted by said panels being arranged adjacent to one another and forming a pile.

For the sake of better visibility, in FIG. 1 the panels have been separated. In an actual stack 1, the web material 2 and hence the panels will be in contact with each other at the fold lines fn. Hence, the dotted lines at the fold lines fn would be replaced by an ordinary fold in an actual stack 1.

In the illustrated portion of a stack 1, the web material is moreover provided with perforation lines pn extending laterally across the web. Hence, sheets of web material are formed, said sheets having a length corresponding to the distance between consecutive perforation lines.

The majority of the sheets have lengths being other than evenly divisible with the stack width sw. This results in that the distance between a perforation line pn and an adjacent fold line fn varies between different perforation lines in the stack. This is sometimes referred to as the perforation lines “wandering” in the stack, since, as seen from the side of the stack as in FIG. 1, the perforation lines pn are located at various distances from the sides of the stack (the fold lines).

(This may be seen in contrast to prior art stacks where the sheets have lengths being evenly divisible with the stack width. In such stacks, the distance between a perforation line and an adjacent fold line will be constant throughout the stack. Hence, the perforation lines do not “wander” as seen from the side of the stack.)

As may be gleaned from FIG. 1, the perforation lines are positioned along the web material 2 such that all perforation lines pn are located at least a distance M from any fold lines in the stack. Hence, all perforation lines pn are separate from any fold lines fn in the stack 1.

This means that there are no perforation lines pn coinciding with any fold lines fn in the stack, and, moreover, that within a distance M from the sides of the stack 1 (the fold lines fn), there will be no perforation lines.

A stack having no perforation lines within a distance M from any fold lines of the stack could possibly be accomplished using a constant sheet length throughout the stack, if the sheet length and other parameters of the stack is optimized for this. However, number of sheet lengths being available for forming such a stack will be very restricted

Hence, advantageously, a stack having no perforation lines within a distance M from any fold lines of the stack may be accomplished by the stack comprising at least two sheets having different sheet lengths, said two sheets not including the end sheets of the stack.

By allowing sheets in the stack 1 to have different sheet lengths, it is possible to avoid placing any perforation lines pn within a distance M from any fold lines fn in the stack. Hence, it will be possible to form such stacks without restrictions as to the nominal sheet length available.

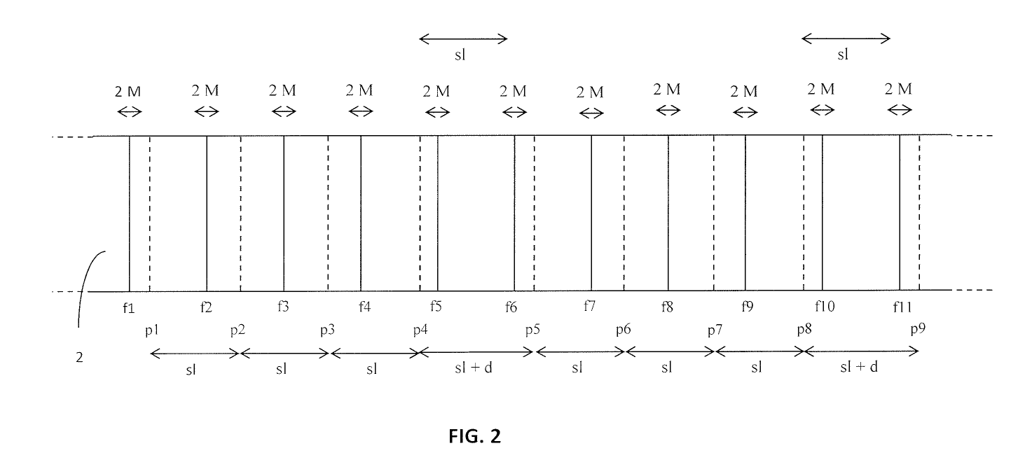

In FIG. 1, it may be gleaned how the distance between the fourth and the fifth perforation line p4 and p5 is different than the distance between e.g. the first and the second perforation line p1 and p2. This will however appear more clearly from FIG. 2.

FIG. 2 illustrates the web material 2 of the portion of the stack 1 of FIG. 1 in an unfolded state. The left hand side in FIG. 2 corresponds to the bottom of the stack 1 of FIG. 1.

In FIG. 2 it is readily seen how the fold lines fn extend laterally across the web material 2 at regular intervals being the stack width sw.

The perforation lines pn extend laterally across the web material, dividing the web material 2 into sheets between consecutive perforation lines pn.

In the illustrated embodiment, it is seen how the sheet formed between the fourth and the fifth perforation lines have a different length than e.g. the sheet formed between the first and the second perforation lines.

Clearly, the distribution of the perforation lines could be made in numerous manners which will all avoid perforation lines within a distance M from any fold lines fn. For example, one could envisage embodiments where the sheet lengths vary from sheet to sheet, or where a number of selected different sheet lengths are used to accomplish a suitable configuration of the perforation lines.

In the illustrated embodiment, the majority of the sheets have a constant nominal sheet length sl. Starting from a first perforation line p1, it is seen how the next perforation line is located at a distance of the nominal sheet length sl from a previous perforation line for the second to third perforation lines p2-p4. In each of these case, the perforation lines p2-p4 naturally end up at a distance greater than M from any fold line.

However, as may be gleaned from the measure indicated at the upper end of the web material 2, when measuring a distance of the nominal sheet length sl from the fourth perforation lines pn, a position lying within the distance M from a perforation line f6 is reached. To avoid this situation, the distance between the fourth perforation line and the fifth perforation line is different than the nominal sheet length sl.

In the illustrated embodiment, the distance between the perforation lines when creating a sheet length other than the nominal sheet length is achieved by adding an offset value (d) to the nominal sheet length.

After the sheet having a different sheet length than the nominal sheet length sl, the perforation lines are again positioned with an interval corresponding to the nominal sheet length sl for the following sixth, seventh and eighth perforation line. The 9 nth perforation line would, if positioned at a distance of the nominal sheet length sl from the 8^{th} perforation line, end up within the distance M from a perforation line. Accordingly, the sheet length between the 8^{th} and the 9^{th} perforation line is different than the nominal sheet length, in this case it is again the nominal sheet length plus an offset value (d).

Hence, as explained in the above, the illustrated embodiment is an example of a stack wherein, when looking from a first end of the web material towards a second end of the web material has a first fold line f1 and a number of following fold lines fn. The position of each following fold line fn is at a distance sw from a previous fold line. The web material 2 moreover has a first perforation line p1 and a number of following perforation lines pn. For each following perforation line pn, if the previous perforation line plus the nominal sheet length sl is not within a distance M from any fold line of the stack, the position of the following perforation line is at the sheet distance sl from a previous perforation line. But if the previous perforation line plus the sheet length sl is within a distance M from any fold line of the stack, the position of the following perforation line is at a distance sl plus an offset value from a previous perforation line.

Moreover, in the embodiment of FIGS. 1 and 2, when considering three consecutive perforation lines (e.g. p4, p5, p6), where the position of the second perforation line (p5) is at a distance of the sheet length sl plus an offset value delta from the first perforation line (p4), the third perforation line (p6) is located at a distance being the nominal sheet length sl from the second perforation line (p4). As may be gleaned from FIG. 2, only one sheet having a length different than the nominal sheet length is created. Accordingly, this embodiment is advantageous if it is desired to have many sheets with the nominal sheet length.

However, the variation of sheet lengths in order to avoid any perforation lines within a distance M from any fold lines may be made in many other manners.

For example, when again considering three consecutive perforation lines, where the position of the second perforation line is at a distance of the nominal sheet length sl plus an offset value from the first perforation line, the third perforation line is located at a distance being two sheet lengths from the second perforation line. In such a case, two sheets having sheet lengths different than the nominal sheet length will be created: one having a length corresponding to the sheet length plus the offset value delta and one having a length corresponding to the sheet length minus the offset value delta.

In the illustrated embodiment, the majority of the sheets have a nominal sheet length sl being 1.2× the stack width sw. Accordingly, the integer is 1 and the constant a is 0.2.

In the illustrated embodiment, the distance M is about 10% of the stack width.

In the illustrated embodiment, the offset value is constant and is +0.2× the stack width.

It is to be noted that the illustrated embodiment has been selected as an illustrative example only. For practical purposes, the various parameters involved may, if desired, be selected e.g. so that as many sheets as possible may have the nominal sheet length sl. Turning to the illustrated embodiment, it is apparent that if for example the offset value was selected to 0.1 the stack width instead of 0.2× the stack width, the second sheet having a different sheet length than the nominal sheet length sl would not appear as quickly after the first sheet having a different sheet length as in the illustrated example.

In the illustrated embodiment, the offset value is a constant, which is added to the nominal sheet length each time there is a need for a sheet having a different sheet length. However, the offset value could also be a variable. A suitable offset value could be calculated for each occasion, with the object of optimizing the stack in view of different parameters.

Also, the offset value could be a variable, but be set such that the distance from the next perforation line to the adjacent fold line is constant. For example, the offset value could be such that the next perforation line is always positioned at the distance M from the adjacent fold line.

Advantageously, an allowable sheet length variation value may be set to determine the limits between which the sheet lengths may vary. Such an allowable sheet length variation value will hence also determine the limits for allowable offset values.

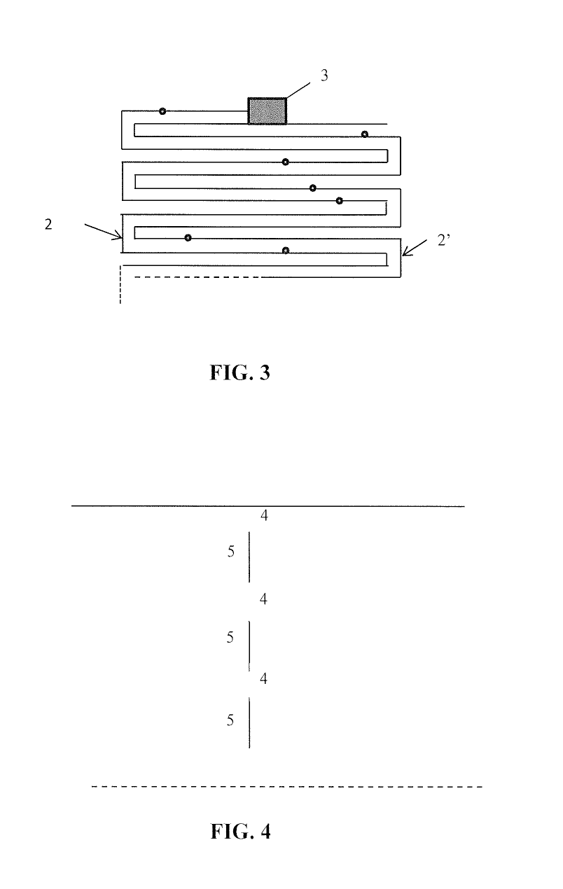

FIG. 3 illustrates schematically an embodiment where the stack comprises two separate web materials 2, 2′ being interfolded. Again no perforation lines (indicated by dots) are seen within a distance M from the fold lines. In this embodiment, the two web materials 2, 2′ are interfolded in relation to each other such that the location of each perforation line of the first web material is positioned between two consecutive perforation lines of the second web material, as seen if the two web materials 2, 2′ were unfolded together.

The stack 1 illustrated in FIG. 3 also includes a connection member 3 for connection of the stack 1 to another stack 1 for use in a dispenser. Various forms and shapes of connection members are known in the prior art and may be used with the disclosure as described herein. Also, the end sheets of the stack 1 may have various lengths or configurations to suit different purposes, e.g. connection to other stacks 1. Various arrangements of end sheets as described in the prior art may also be combined with this disclosure.

The perforation lines may be formed by various shapes and configurations of perforations and remaining bonded areas, to accomplish the division of the web material 2 into sheets. The perforations may form a regular, constant pattern over the width of the web material 2, or may for intermittent patterns.

The bonded area remaining between perforations may be referred to as “tabs” 4, and the perforations may be referred to as “slots” 5. In FIG. 4, an exemplary embodiment is illustrated. Hence, the perforation lines are formed by alternating tabs 4 and slots 5. Advantageously, a remaining bonded length may be defined using the total tab length (the sum of the lengths of all tabs of a line in a direction transverse the web) and a total slot length (the sum of the lengths of all slots of a line in a direction transverse the web), as the total tab length/(total tab length+total slot length). (The total tab length+total slot length is the length of the perforation line in a direction transverse the web material.)

Advantageously, the remaining bonded length may be between 4 and 15%:

In an embodiment of the method in accordance with the disclosure, a method is provided for producing a stack 1 as described in FIGS. 1 and 2. The method comprises providing a web section of web material 2, selecting a stack width sw being equal to the distance between two consecutive fold lines of said web material 2, and determining the final positions of the fold lines fn. Moreover, the method comprises determining the final positions of the perforation lines pn so as to achieve a stack 1 in accordance with the embodiment of FIGS. 1 and 2.

To this end, the perforation lines are distributed such that the majority of the sheets have a length being other than evenly divisible with the stack width, and that all final position s of the perforation lines are located at least a distance M along the web material from any fold line.

In the embodiment of the method, the method comprises in addition the selection of the nominal sheet length sl, being the nominal distance between two consecutive perforation lines of the web material, where sl=(an integer+a) c sw (1.2×sw in the example), and distributing the perforation lines such that a majority of the sheets formed by the method will have the nominal sheet length.

To this end, the method may comprise selecting the position of a first perforation line p1 of on the web material, and determining the nominal position of each next perforation lie along the web material by adding the nominal sheet length sl to the position of a previous perforation line pn-1. Thereafter, the nominal position of each next perforation line pn is compared with the final positions of the fold lines f1-n and, if the nominal position is not within a distance M from any fold line, the final position of that perforation line pn becomes the nominal position. This is the case when determining the final positions of e.g. lines p2, p3 and p4 in FIG. 2.

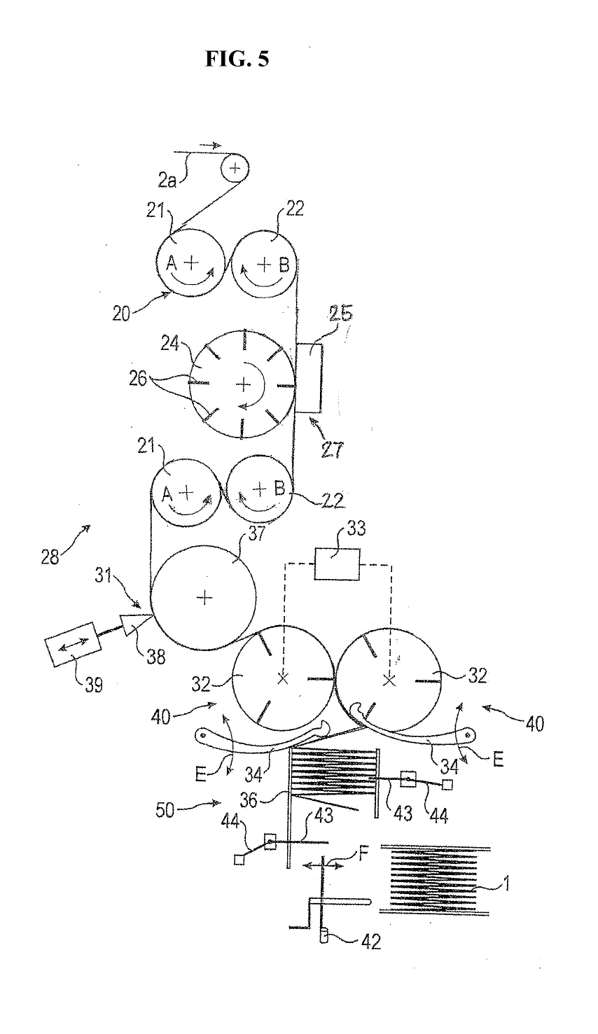

However, if the nominal position of a perforation line is within a distance less than M from any fold line, a final position for that perforation line is created by adding an offset value to the nominal position. This is the case when determining the final position of e.g. the fifth perforation line p5 in FIG. 2. The nominal position of the 5th perforation line p5 is located at the distance of the nominal sheet length sl from the 4^{th} perforation line p4. This location is marked with a cross at the upper end of the web in FIG. 5. Since the nominal position of the 5^{th} perforation line p5 is located within a distance M from the fold line f6, a new final position of the 5^{th} perforation line is created, at a distance of the nominal sheet length plus an offset value from the 4^{th} perforation line.

With the method in accordance with the described embodiment, or any other method for determining the final positions of the perforation lines, those final positions will be determined before the step of feeding the web material to a perforation station and to apply perforations at the determined final positions.

Advantageously, the necessary calculations for performing the evaluations may be made in a processor, which may likewise be arranged to receive input such as a selected stack width sw, nominal sheet length sl, and if desired also restrictions to the offset values or allowed sheet length variation values. The processor may be used to distribute the perforation lines in accordance with a predefined method, such as one of the distribution methods disclosed herein. Alternatively, or in combination thereto, the processor may be used to generate and compare different alternatives in order to optimize the distribution of the perforation lines. The optimization may be made after various parameters. For example, a solution may be desired which allows for as many sheets as possible having the nominal sheet length.

The method proposed herein includes directing the web material to a perforating station, perforating the web material, directing the web to a folding station, and folding the web material.

In addition, the method may advantageously comprise a step of directing a continuous web to a cutting station and cutting said web into sections. The cutting step is preferably perforated after the step of perforating the web material and before the step of folding the web material.

For enabling use of the method, with the possibility of selecting and/or altering the input parameters, and to achieve a stack in accordance with what is proposed herein regardless of the input parameters, it is advantageous to use a production equipment which allows for sufficient versatility.

FIG. 5 schematically shows an embodiment of an apparatus for producing a stack as illustrated in FIG. 1.

A continuous web 2a is continuously conveyed to a first tensioning device 20. The first tensioning device consists of two rollers which are rotated in opposite directions A and B and around which the web 2a is wound in an S-shaped manner. There is a gap between the two rollers 21, 22 so that the web 2a is not pinched in a nip between the two tensioning rollers. Due to the S-shaped contact of the webs around the rollers 21, 22, a high contact area between the web and the rollers is generated leading to a high friction between the webs and the rollers. In order to increase the friction, conventional methods can be applied like varying the surface roughness of the circumferential surface of rollers 21, 22. A convenient way of increasing the friction is to cover the circumferential surfaces of the rollers with tungsten. Due to the friction between the web 2a and the first tensioning device 20, the transport speed of the web 2a is brought exactly to the circumferential speed of rollers 21, 22.

After leaving the first tensioning device 20, the web 12a is directed to a perforation station 27 with a perforation roller 24 which acts against an anvil element 25, respectively. The perforation roller 24 is rotated at a circumferential speed which can be different to the transport speed of the webs 2a. The circumferential speed of the perforation rollers can be adjusted within a range of −60% and +40% relative to the conveying speed of the web 2a.

The perforation roller is provided with several perforation knives 26 which, can be selectively activated or put in an idle state. This serves to use the device for placing perforations at the determined final positions for the perforation lines.

The perforation roller generates perforation lines which run perpendicular to the length direction of the web 2a. In order to avoid vibration of the perforation rollers, the time period of the perforation action can be extended by providing helical perforating elements to generate a continuously moving position at which a perforating element penetrates into the web 2a.

Subsequent to the perforation roller 24, there is a second tensioning device 20 which uses the same principle as explained above for the first tensioning device.

Preferably, the conveying speed of web 2a at the second tensioning device is slightly higher than the conveying speed of the webs at the first tensioning device. The difference in speed can be up to 1%. This serves to tighten the web at the position at which the web runs through the perforating station 27.

After leaving the second tensioning device, the web 2a is directed to a cutting station 31 comprising anvil rollers 37 and cutting knives 38 which are functionally coupled to a suitable mechanism 39 which moves the cutting knife 38 in a reciprocating manner. When operated, the cutting knife 38 provides either a clean cut or a tab-bond so as to divide the web 2a into individual web sections 2. The web sections are then transported to the vacuum folding device generally denoted by reference numeral 40. The mechanism 39 can be a cam mechanism or an electrically operated mechanism like a piezoelectric actuator.

When leaving the cutting station 31, the web sections 2 are directed to a vacuum station 40 with vacuum folding rollers 32 which are connected to a device 33 generating sub-atmospheric pressure at parts of the circumference of the vacuum folding rollers 32. This serves to make the web alternately adhere to one of the two vacuum folding rollers which operatively cooperate with packer fingers 34 which are moved in the direction of arrows E and are used to separate the web sections 2 from the vacuum folding rolls 32 and to direct the folded web section 2 into the stacking station 50.

The stacking device 36 can be of any conventional type known to a skilled person. It is provided with a loader finger 42 adapted for a reciprocating movement in the direction of arrow F, separator fingers 43 moving upwards and downwards in the vertical stacking arrangement and count fingers 44 which work together to count a predetermined number of folded sheets before the separator fingers cut off the web sections in case of still existing tab-bonds and before a finished stack is moved downwards and conveyed by loader finger 42 in the direction perpendicular to the stacking direction and away from the device.

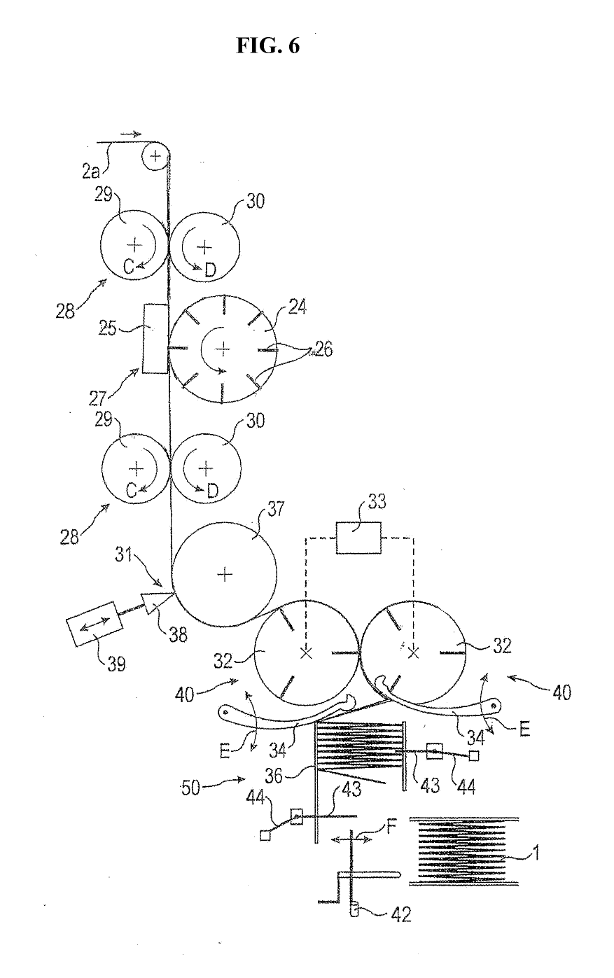

FIG. 6 is very similar to FIG. 5 and serves to schematically show a different type of tensioning device. In FIG. 6, tensioning devices 28 upstream and downstream the perforating device 27 are used which are embodied as the nip between two rollers 29, 30 rotating in opposite directions C, D. The first and second tensioning devices 20, 28 as shown in FIGS. 5 and 6 are only examples of possibilities to provide a tensioning of web 2a and any variation of S-wraps around rollers and nips between rollers can be freely varied.

Although in the schematic representation a horizontal stacking machine has been shown, an aspect of the disclosure can also be realized when using a horizontal stacking machine. However, besides the perforating device 27, a separate cutting device 31 is provided so that the position of the end edges of the top panels within one stack can be freely selected according to the specific needs of the user.

The perforation lines can be made mechanically strong enough so that they can withstand the gravity force in an upwards dispensing dispenser with a considerable height of its supply magazine. Further, free selection can be made whether clear cuts or tab-bonds are realized in the cutting station since this operation is fully independent of the perforation step.

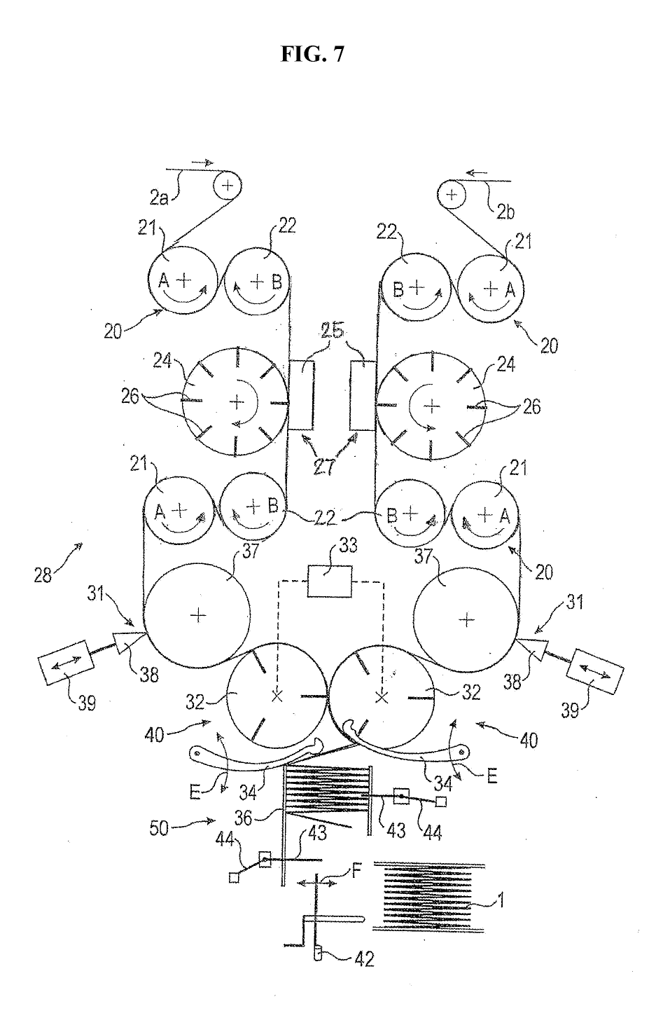

FIG. 7 illustrates schematically an apparatus being similar to that of FIG. 5, but for simultaneously processing two webs 2a, 2b. The equipment is hence doubled, until the and the webs 2a, 2b are processed independently up to the folding rollers. At the folding rollers, the webs 2a, 2b are interfolded to form a common stack 1.

Nevertheless, a central control unit is provided so that the perforation lines and clear cuts or tab-bonds can be adequately provided and positioned, preferably offset to each other, in order to realize an interfolded stack as explained above with reference to FIG. 3.

Various alternatives and embodiments of the stack and the method as described in the above will be readily understood by the person skilled in the art.

Whilst the person skilled in the art will realise that the best result is achieved if the stack is formed such that “all”, meaning 100% of the perforation lines are separate from any fold lines in the stack, it is nevertheless contemplated that a sufficient result might be achieved when “all”, meaning “sufficiently all”, of the perforation lines are separate from any fold lines in the stack. “Sufficiently all” might for example be more than 95%, or more than 98%, of the perforation lines in the stack. This could particularly be the case for stacks including a relatively large number of sheets.

1. A stack of a web material, said stack comprising
fold lines extending laterally across the web material, a distance between two consecutive fold lines being equal to the stack width (sw), and
perforation lines extending laterally across the web, to form sheets of web material having a length corresponding to the distance between consecutive perforation lines,
a majority of said sheets having sheet lengths being greater than the stack width (sw) and other than evenly divisible with the stack width (sw),
wherein the perforation lines are positioned along the web material such that all perforation lines are located at least a distance M from any fold lines in the stack, wherein all perforation lines are separate from any fold lines in the stack.

2. A stack in accordance with claim 1, wherein the distance M is less than or equal to 2% of the stack width (sw).

3. A stack in accordance with claim 1, wherein said distance M is less than or equal to 2 mm, preferably 5 mm.

4. A stack in accordance with claim 1, wherein said stack comprises at least two sheets having different sheet lengths, said two sheets not including end sheets of the stack.

5. A stack in accordance with claim 1, wherein a majority of said sheets have a nominal sheet length (sl), said nominal sheet length (sl)=((an integer+a)×sw)), where 0<a<1.

6. A stack in accordance with any claim 5, wherein the stack comprises at least one sheet having a sheet length different than the nominal sheet length (sl), which at least one sheet is not an end sheet of the stack.

7. A stack in accordance with claim 6, wherein, for each sheet in the stack having a sheet length being different than the nominal sheet length (sl), and not being an end sheet of the stack, a difference between the length of that sheet and the nominal sheet length (sl) is below an allowed length variation value (Ivv).

8. A stack in accordance with claim 7, wherein said allowed length variation value (Ivv) is less than 25% of the nominal sheet length (sl).

9. A stack according to claim 5, comprising a number of sheets n being greater than or equal to sw/a.

10. Stack according to claim 1, comprising at least 20 sheets.

11. Stack in accordance with claim 1, wherein the stack width is between 4 cm and 20 cm.

12. Stack in accordance with claim 5, wherein the nominal sheet length (sl) is between 8 cm and 80 cm.

13. Stack in accordance with claim 5, wherein the ratio between the sheet length and the stack width is between 2 and 8.

14. Stack in accordance with claim 5, wherein the integer is greater than or equal to 1.

15. Stack in accordance with claim 5, wherein a is greater than 0.05.

16. Stack in accordance with and claim 5, wherein (an integer+a) is in the range 2-4.

17. Stack in accordance with claim 1, wherein the perforation lines are formed by alternating bonds and slots, and a remaining bonded length being the total bond length/(total bond length+total slot length) is between 4% and 50%.

18. Stack in accordance with claim 1, wherein the stack comprises two separate web materials being interfolded.

19. Stack in accordance with claim 18, wherein the two web materials are interfolded in relation to each other such that a location of each perforation line of the first web material is positioned between two consecutive perforation lines of the second web material.

20. Stack in accordance with claim 5, wherein the first perforation line of the web is positioned at a distance equal to the sheet length from a leading edge of the web.

21. Stack in accordance with claim 1, wherein at least one end of the stack is provided with a connection member for connection to the web material of another stack, when the stack is introduced in a dispenser for dispensing the web product.

22. Stack in accordance with claim 7, wherein, when looking from a first end of the web material towards a second end of the web material,
the web material has a first fold line, and a number of following fold lines, the position of each following fold line being at the distance sw from a previous fold line,
the web material has a first perforation line, and a number of following perforation lines, and
for each following perforation line, if the previous perforation line plus sl is not within a distance M from any fold line of the stack, the position of the following perforation line is at a distance sl from a previous perforation line,
but if the previous perforation line plus sl is within a distance M from any fold line of the stack, the position of the following perforation line is at a distance sl plus an offset value from a previous perforation line.

23. Stack according to claim 22, wherein, when considering three consecutive perforation lines, where a position of a second perforation line is at a distance of the sheet length (sl) plus an offset value from a first perforation line, a third perforation line is located at a distance being a sheet length from the second perforation line.

24. Stack according to claim 22, wherein, when considering three consecutive perforation lines, where a position of a second perforation line is at a distance of the sheet length (sl) plus an offset value from a first perforation line, a third perforation line is located at a distance being two sheet lengths from the second perforation line

25. Stack in accordance with claim 22, wherein the offset value is within said allowable length variation value (Ivv).

26. Method for producing a stack of a folded and perforated web material in accordance with claim 1, said method comprising:
providing a web section of a web material;
selecting a stack width (sw), being equal to the distance between two consecutive fold lines of said web material;
determining the final positions of the fold lines along the web material;
determining the final positions of the perforation lines along the web material, by distributing the perforation lines such that
the majority of the sheets formed between consecutive perforation lines have a sheet length being other than evenly divisible with the stack width (sw), and
all final positions of the perforation lines are located at least a distance M along the web material from any fold line;
directing the web material to a perforating station;
perforating the web material at the determined final positions of the perforation lines;
directing the web material to a folding station; and
folding the web material at the determined final positions of the fold lines to form said stack.

27. Method according to claim 26, wherein said web section is formed from a continuous web of material, the method further comprising the step of directing the continuous web to a cutting station and cutting the continuous web into web sections.

28. Method according to claim 27, wherein said step of cutting the continuous web into web sections is performed after the step of perforating the web material and before step of folding the web material.

29. Method in accordance with claim 26, comprising
selecting the position of a first fold line on the web material, and
determining the final positions of the fold lines along the web material by, for each next fold line, adding the stack width (sw) to the position of a previous fold line.

30. Method in accordance with claim 26, comprising
selecting a nominal sheet length (sl), being a nominal distance between two consecutive perforation lines of the web material, where sl=(an integer+a)×sw, where 0<a<1, and
distributing the perforation lines such that a majority of the sheets formed by the method will have the nominal sheet length (sl).

31. Method in accordance with claim 30, comprising selecting an allowed length variation value (Ivv), and distributing the perforation lines such that all sheets between the end sheets of the stack will have sheet lengths within the range of the nominal sheet length+−the allowed length variation value.

32. Method in accordance with claim 30, comprising determining the final positions of the perforation lines along the web by selecting the position of a first perforation line on the web material, and determining the nominal position of each next perforation line along the web material by adding the nominal sheet length sl to the position of a previous perforation line,
comparing the nominal position of said next perforation line with the final positions of the fold lines, and,
if the nominal position of the next perforation line is located at a distance less than M from any fold line, create a final position for the next perforation line being at least the distance M from the final position of any fold line by adding an offset value to the nominal position, or
if the nominal position of the next perforation line is not within a distance M from the final position of any fold line, the nominal position for the next perforation line becomes the final position.

33. Method according to claim 32, wherein, for a next perforation line following a previous perforation line whose final position was achieved by adding an offset value to the nominal position, the previous fold line is the final position of the previous perforation line.

34. Method according to claim 32 wherein, for a next perforation line following a previous perforation line whose final position was achieved by adding an offset value to the nominal position, the previous fold line is the nominal position of the previous perforation line.

35. Method in accordance with claim 26, wherein the method comprises forming a stack of two perforated web materials, said web materials being interfolded to form said stack.

36. Method in accordance with claim 35, wherein said perforating and interfolding of the two web materials is controlled such that each perforation line of the first web material is positioned between two consecutive perforation lines of the second web material.

37. Dispenser for dispensing sheets of web material to a user, said dispenser containing a stack in accordance with claim 1.
